(19) United States
(12) Patent Application Publication
(10) Pub. No.: US 2021/0037719 A1
(43) Pub. Date: Feb. 11, 2021

(54) PLANETARY WEATHER MODIFICATION SYSTEM

(71) Applicants: Colette Nagami, Laguna Niguel, CA (US); Glen Nagami, Laguna Niguel, CA (US)

(72) Inventors: Colette Nagami, Laguna Niguel, CA (US); Glen Nagami, Laguna Niguel, CA (US)

(21) Appl. No.: 16/536,554

(22) Filed: Aug. 9, 2019

(51) Int. Cl. A01G 15/00; G05D 1/10; G05D 1/00

(52) U.S. Cl. CPC A01G 15/00; G05D 1/0027; G05D 1/0022; G05D 1/104

(57) ABSTRACT

A planetary weather modification system comprises a plurality of solar powered unmanned aerial vehicles (UAVs) in communication via a communication network. The UAVs receive a flight instruction to fly in close proximity so as to block the light emanating from the Sun and casting a shadow on the surface of the Earth. The UAVs may fly in circular formation, elliptical formation, rectangular formation, or a vertical column formation. The number of the plurality of the UAVs maybe large enough so as to affect the temperature within an umbral diameter of the shadow so cast on the surface of the Earth.

### COPYRIGHT

A portion of the disclosure of this patent document contains material which is subject to copyright protection. The owner has no objection to the facsimile reproduction by anyone of the patent disclosure, as it appears in the Patent and Trademark Office files or records, but otherwise reserves all copyright rights whatsoever.

### FIELD OF INVENTION

The present invention relates to a planetary weather modification system and method which includes a communication network and a plurality of solar powered unmanned aerial vehicles (UAVs). The UAVs are in communication with the communication network and receive a flight control instruction from the communication network to fly in close proximity above the surface of the Earth. The electromagnetic waves, including those residing in the visible spectrum, emanating from the Sun and impinging upon the Earth are substantially reduced or completely eliminated by the UAVs as they cast a shadow on the surface of the Earth, thereby, modifying the weather at least inside the region defined by the umbral diameter.

### BACKGROUND

A UAV, commonly referred to as a drone, is an aircraft which operates without a human pilot at the control. UAVs can be operated by remote control or autonomously via a communication network and/or onboard computers. Originally, UAVs were designed and developed for military applications but their use have expanded substantially into commercial, scientific, surveillance, and many civilian applications such as product delivery, aerial photography, and recreational use.

Solar powered UAVs have been developed by a number aircraft companies such as AeroVironment, Inc., Titan Aerospace, BAE Systems PLC, and Prismatic Ltd, just to name a few. These solar powered UAVs are fitted with lithium-ion batteries and ultra-lightweight gallium arsenide solar cells which allow them to remain at altitudes between 55,000 and 70,000 feet for several years.

Global warming or climate change have been attributed to human activities on Earth such as emission of carbon into Earth's atmosphere. The effects of climate change include Earth's unprecedented temperature rise during the 20′ century. This rise in temperature has manifested itself in extreme weather events such as tropical depressions, storms, tornadoes, hurricanes, etc. The severity of these weather events has increased over time and proportionally to the rise in Earth's temperature.

A solar eclipse occurs when the Moon is positioned between the Sun and the Earth so as to cast a complete (full eclipse) or a partial (partial eclipse) shadow on the surface of the Earth. It has been recorded that the shadow cast by the Moon on the surface of the Earth, during an eclipse of the Sun, causes a decrease in temperature in the region defined by the shadow. The region is quantified as the umbral diameter which may be simplified in math and approximated by the following equation:

Umbral Diameter˜2*(m*S−M*s)/(S−M); where

m=Moon Radius;
M=Moon Distance from Earth's Surface;
s=Sun Radius; and
S=Sun Distance from Earth's Surface.

The present invention is directed at creating a shadow on the surface of the Earth, utilizing a plurality of flying solar powered UAVs in close proximity to one another, so as to lower or otherwise influence the temperature within the umbral diameter. This change in temperature may be used to mitigate or otherwise control the detrimental effects of the above-mentioned weather events.

### SUMMARY

In one aspect, a planetary weather modification system is disclosed wherein the system comprises a communication network and a plurality of solar powered unmanned aerial vehicles (UAVs) in communication with the communication network, wherein the UAVs are configured to receive a flight control instruction from the communication network causing them to fly in close proximity to one another so as to at least one of substantially reduce and eliminate electromagnetic radiation impinging upon the Earth from the Sun.

Preferably, the communication network comprises one or more satellite orbiting the Earth.

Preferably, the communication network comprises one or more ground control station.

Preferably, the UAVs comprise at least one of a first number of fixed wing UAVs and a second number of rotary wing UAVs.

Preferably, the flight control instruction further causes the UAVs to fly at an altitude above the Earth's surface and according to one of a substantially circular formation, a substantially elliptical formation, a substantially rectangular formation, and a substantially vertical column formation.

Preferably, a radius of the substantially circular formation is equal to 10 kilometers and the altitude is equal to 20 kilometers.

Preferably, the communication network is configured to receive an emergency signal associated with an emergency event at a location on the Earth and the flight control instruction further causes the UAVs to fly to the location.

Preferably, the communication network is included in one of the UAVs.

Preferably, the UAVs are further configured to communicate with one another, via the communication network.

In another aspect, a method for planetary weather modification is disclosed wherein the method comprises providing a communication network and providing a plurality of solar powered unmanned aerial vehicles (UAVs) in communication with the communication network, wherein the UAVs are configured to receive a flight control instruction from the communication network causing them to fly in close proximity to one another so as to at least one of substantially reduce and eliminate electromagnetic radiation impinging upon the Earth from the Sun.

Preferably, the communication network comprises one or more satellite orbiting the Earth.

Preferably, the communication network comprises one or more ground control station.

Preferably, the UAVs comprise at least one of a first number of fixed wing UAVs and a second number of rotary wing UAVs.

Preferably, the flight control instruction further causes the UAVs to fly at an altitude above the Earth's surface and according to one of a substantially circular formation, a substantially elliptical formation, a substantially rectangular formation, and a substantially vertical column formation.

Preferably, a radius of the substantially circular formation is equal to 5 kilometers and the altitude is equal to 10 kilometers.

Preferably, the communication network is configured to receive an emergency signal associated with an emergency event at a location on the Earth and the flight control instruction further causes the UAVs to fly to the location.

Preferably, the communication network is included in one of the UAVs.

Preferably, the UAVs are further configured to communicate with one another, via the communication network.

In another aspect, a method for planetary weather modification is disclosed wherein the method comprises flying a plurality of solar powered unmanned aerial vehicles (UAVs) in close proximity to one another so as to at least one of substantially reduce and eliminate electromagnetic radiation impinging upon the Earth from the Sun, wherein the UAVs are in communication with a communication network and configured to receive a flight control instruction from the communication network.

Preferably, the method further comprises flying the UAVs at an altitude above the Earth's surface and according to one of a substantially circular formation, a substantially elliptical formation, a substantially rectangular formation, and a substantially vertical column formation.

Preferably, a radius of the substantially circular formation is equal to 20 kilometers and the altitude is equal to 7 kilometers.

Preferably, the communication network is configured to receive an emergency signal associated with an emergency event at a location on the Earth, said method further comprising flying the UAVs to the location.

### DESCRIPTION OF THE DRAWINGS

FIG. 1 shows a perspective view of a planetary weather modification system utilized to block the light emanating from the Sun and casting a shadow on the surface of the Earth.

FIG. 2 shows a top view of a plurality of UAVs flying in close proximity in a substantially circular formation.

FIG. 3 shows a top view of a plurality of UAVs flying in close proximity in a substantially elliptical formation.

FIG. 4 shows a top view of a plurality of UAVs flying in close proximity in a substantially rectangular formation.

FIG. 5 shows a side view of a plurality of UAVs flying in close proximity at an altitude above the surface of the Earth in a substantially circular formation having a diameter D and casting a shadow of umbra diameter U_{D} on the surface of the Earth.

### DETAILED DESCRIPTION OF THE PRESENTLY PREFERRED EMBODIMENTS

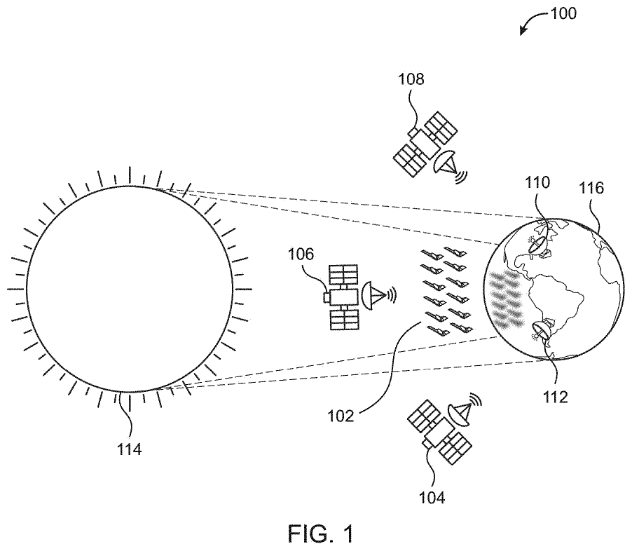

FIG. 1 depicts a perspective view 100 (not in scale) of a planetary weather modification system according to a preferred embodiment. The system may be used to block the light emanating from the Sun and casting a shadow on the surface of the Earth. The system includes a plurality of UAVs 102 and a communication network which includes satellites 104, 106, and 108, and ground control stations 110 and 112. The Sun 114 radiates electromagnetic waves which propagate through space and impinge upon the surface of the Earth 116. The visible spectrum of the electromagnetic waves, i.e., the light waves, are blocked by the plurality of UAVs 102 which is manifested by a shadow 118 on the surface of the Earth 116.

Known to artisans of ordinary skill, when an opaque object is positioned in the path of a light source, there are three distinct parts created by the light source after impinging upon the opaque object. These three parts are commonly referred to as the umbra, penumbra, and antumbra. Focusing on the umbra, it is the innermost and darkest part of a shadow, where the light source is completely blocked by the opaque body. Assuming the opaque body to be a perfect sphere, a close approximation of the umbral diameter of the shadow on the surface of the Earth 116 can be calculated according to the equation:

Umbral Diameter˜2*(b*S−B*s)/(S−B); (1)

where
b=Opaque Body Radius;
B=Opaque Body Distance from Earth's Surface;
s=Sun Radius; and
S=Sun Distance from Earth's Surface.

Neglecting diffraction effects, the plurality of UAVs 102 flying in close proximity to one another at an altitude above the surface of the Earth 116 will cast a shadow on the surface of the Earth 116, the umbral diameter of which may be approximated by equation (1). Accordingly, the temperature of the region within the umbral diameter is lowered which can be advantageously utilized to affect weather events in that region.

The plurality of UAVs 102 utilize the solar power of the Sun 114 to power their engines. According to a preferred embodiment, the plurality of UAVs 102 are in communication with the communication network 104, 106, 108, 110, and 112. Each of the plurality of UAVs 102 may be initially located at a different location on the Earth 116. Each of the plurality of UAVs 102 is configured to receive a flight control instruction from the communication network 104, 106, 108, 110, and 112. The flight control instruction causes the plurality of UAVs 102 to come to a formation and fly in close proximity to one another, thereby, blocking the light emanating from the Sun 114 that would be otherwise impinging upon the surface of the Earth 116. Each of the UAVs 102 may be a fixed wing or a rotary wing UAV.

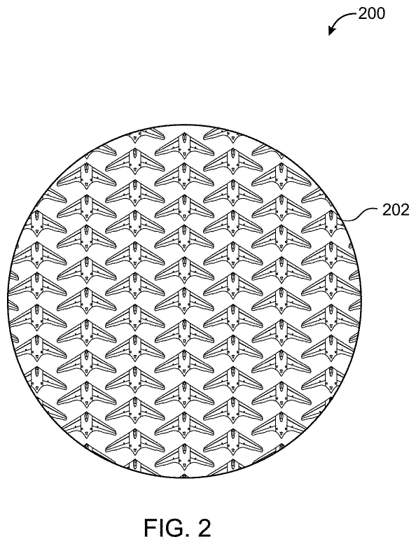

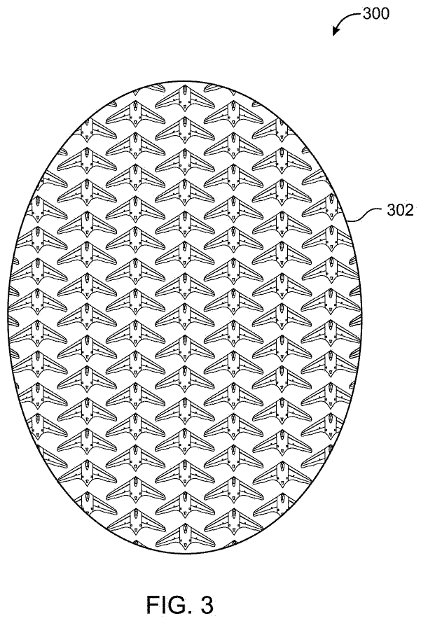

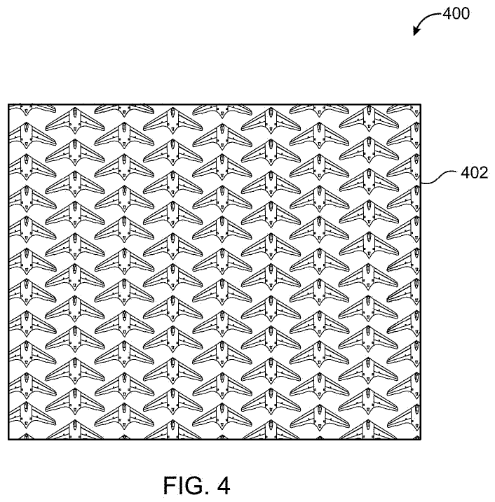

FIGS. 2 through 4 depict top views of plurality of UAVs 200, 300, and 400 flying in close proximity in a substantially circular formation 202, a substantially elliptical formation 302, and a substantially rectangular formation 402, respectively. In each of these formations, the plurality of UAVs 200, 300, and 400, are in communication with a communication network, such as the communication network 104, 106, 108, 110, and 112, and are configured to receive their flight control instructions to make the formations. In a preferred embodiment (not shown), the plurality of UAVs 200, 300, or 400 fly in close proximity in a substantially vertical column formation. This embodiment is desirable to allow greenhouse gases to escape during the night, preventing the clouds of drones themselves to contribute to increased greenhouse gases.

Referring back to FIG. 1, the communication network 104, 106, 108, 110, and 112 may be further configured to receive an emergency signal associated with an emergency event at a location on the Earth 116. For instance, the weather condition at the location is favorable for the creation of tornados. As such, the location is communicated with the communication network 104, 106, 108, 110, and 112 which in turn communicates with the plurality of UAVs 102 to fly to that location. When the plurality of UAVs 102 arrive at that location they may form any of the above-mentioned circular, elliptical, or rectangular formation to substantially reduce or eliminate electromagnetic radiation impinging upon the Earth 116 from the Sun 114 at that location. The temperature reduction within the associated umbral diameter is expected to prevent the formation of tornados inside the umbra diameter.

In a preferred embodiment, the communication network is a single unit which reside in one of the plurality of UAVs 102. In this embodiment, there is no need to employ satellites 104, 106, 108 or the ground control stations 110, and 112. In yet another embodiment, the plurality of UAVs 102 are further configured to communicate with one another, via the communication network 104, 106, 108, 110, and 112. For instance, further and more accurate flight control instructions may be achieved by continually receiving location signals from each of the plurality of UAVs 102.

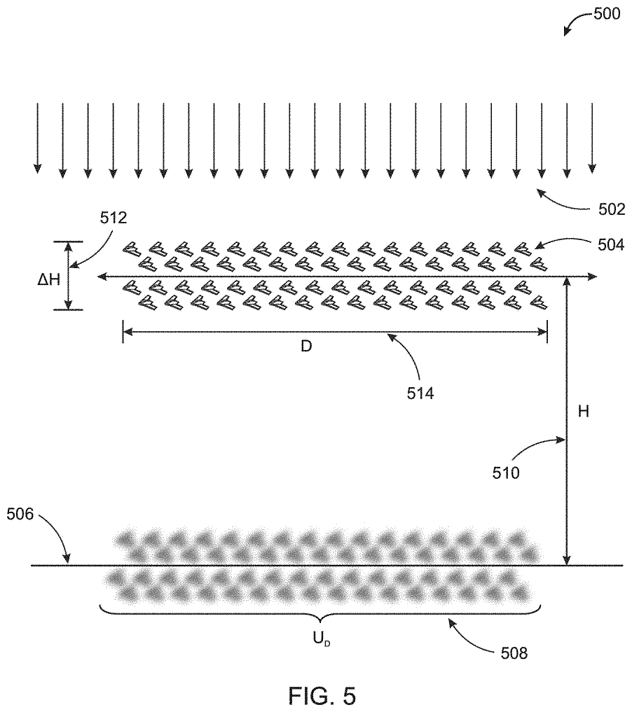

FIG. 5 depicts a side view 500 of a plurality of UAVs 504 flying in close proximity at an altitude H at 510 above the surface of the Earth 506 in a substantially circular formation having a diameter D at 514 and casting a shadow of umbra diameter U_{D} at 508 on the surface of the Earth 506. The Sun's electromagnetic radiation 502 which would otherwise impinge upon the surface of the Earth 506 is substantially reduced or eliminated by the plurality of UAVs 504. A communication network (not shown) issues a flight control instruction to the plurality of UAVs 504 to fly in close proximity to one another at the altitude H at 510 above the Earth's surface 506 and according to a substantially circular formation.

Per the flight control instruction, each of the plurality of UAVs 504 is configured to fly at the altitude H at 510. However, in actuality, each of the plurality of UAVs 504 flies at the altitude H at 510 but within an envelope AH at 512. In a preferred embodiment, the diameter D at 514 of the substantially circular formation is equal to 20 kilometers and the altitude H at 510 is also equal to 20 kilometers. Using Equation (1), U_{D} at 508 is calculated as:

U_{D}˜2*(10*151,316,506−20*695700)/(151,316,506−20)˜20 kilometers.

In another embodiment, the diameter D at 514 of the substantially circular formation is equal to 10 kilometers and the altitude H at 510 is also equal to 10 kilometers. Using Equation (1), U_{D} at 508 is calculated as:

U_{D}˜2*(5*151,316,506−10*695700)/(151,316,506−10)˜10 kilometers.

In yet another embodiment the diameter D at 514 of the substantially circular formation is equal to 40 kilometers and the altitude H at 510 is also equal to 7 kilometers. Using Equation (1), U_{D} at 508 is calculated as:

U_{D}˜2*(20*151,316,506−7*695700)/(151,316,506−7)˜40 kilometers.

The foregoing explanations, descriptions, illustrations, examples, and discussions have been set forth to assist the reader with understanding this invention and further to demonstrate the utility and novelty of it and are by no means restrictive of the scope of the invention. It is the following claims, including all equivalents, which are intended to define the scope of this invention.

What is claimed is:

1. A planetary weather modification system, comprising:
a communication network; and
a plurality of solar powered unmanned aerial vehicles (UAVs) in communication with the communication network;
wherein the UAVs are configured to receive a flight control instruction from the communication network causing them to fly in close proximity to one another so as to at least one of substantially reduce and eliminate electromagnetic radiation impinging upon the Earth from the Sun.

2. The system of claim 1, wherein the communication network comprises one or more satellite orbiting the Earth.

3. The system of claim 1, wherein the communication network comprises one or more ground control station.

4. The system of claim 1, wherein the UAVs comprise at least one of a first number of fixed wing UAVs and a second number of rotary wing UAVs.

5. The system of claim 1, wherein the flight control instruction further causes the UAVs to fly at an altitude above the Earth's surface and according to one of a substantially circular formation, a substantially elliptical formation, a substantially rectangular formation, and a substantially vertical column formation.

6. The system of claim 5, wherein a radius of the substantially circular formation is equal to 10 kilometers and the altitude is equal to 20 kilometers.

7. The system of claim 1, wherein the communication network is configured to receive an emergency signal associated with an emergency event at a location on the Earth and the flight control instruction further causes the UAVs to fly to the location.

8. The system of claim 1, wherein the communication network is included in one of the UAVs.

9. The system of claim 1, wherein the UAVs are further configured to communicate with one another, via the communication network.

10. A method for planetary weather modification, comprising:
providing a communication network; and
providing a plurality of solar powered unmanned aerial vehicles (UAVs) in communication with the communication network;
wherein the UAVs are configured to receive a flight control instruction from the communication network causing them to fly in close proximity to one another so as to at least one of substantially reduce and eliminate electromagnetic radiation impinging upon the Earth from the Sun.

11. The method of claim 10, wherein the communication network comprises one or more satellite orbiting the Earth.

12. The method of claim 10, wherein the communication network comprises one or more ground control station.

13. The method of claim 10, wherein the UAVs comprise at least one of a first number of fixed wing UAVs and a second number of rotary wing UAVs.

14. The method of claim 10, wherein the flight control instruction further causes the UAVs to fly at an altitude above the Earth's surface and according to one of a substantially circular formation, a substantially elliptical formation, a substantially rectangular formation, and a substantially vertical column formation.

15. The method of claim 14, wherein a radius of the substantially circular formation is equal to 5 kilometers and the altitude is equal to 10 kilometers.

16. The method of claim 10, wherein the communication network is configured to receive an emergency signal associated with an emergency event at a location on the Earth and the flight control instruction further causes the UAVs to fly to the location.

17. The method of claim 10, wherein the communication network is included in one of the UAVs.

18. The method of claim 10, wherein the UAVs are further configured to communicate with one another, via the communication network.

19. A method for planetary weather modification, comprising:
flying a plurality of solar powered unmanned aerial vehicles (UAVs) in close proximity to one another so as to at least one of substantially reduce and eliminate electromagnetic radiation impinging upon the Earth from the Sun, wherein the UAVs are in communication with a communication network and configured to receive a flight control instruction from the communication network.

20. The method of claim 19, further comprising flying the UAVs at an altitude above the Earth's surface and according to one of a substantially circular formation, a substantially elliptical formation, a substantially rectangular formation, and a substantially vertical column formation.

21. The method of claim 20, wherein a radius of the substantially circular formation is equal to 20 kilometers and the altitude is equal to 7 kilometers.

22. The method of claim 19, wherein the communication network is configured to receive an emergency signal associated with an emergency event at a location on the Earth, said method further comprising flying the UAVs to the location.
